(19) United States
(12) Patent Application Publication
(10) Pub. No.: US 2008/0174412 A1
(43) Pub. Date: Jul. 24, 2008

(54) Electronic alert system for manual planner

(76) Inventors: Kurt Sward, Deerfield, IL (US); Iulius Lucaci, Evanston, IL (US); Mark Fastabend, Chicago, IL (US); Evan Ward, Chicago, IL (US); Craighton Berman, Chicago, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/657,835

(22) Filed: Jan. 23, 2007

(51) Int. Cl. B42D 5/00

(52) U.S. Cl. 340/309.7

(57) ABSTRACT

The present invention generally provides a binder or planner system. The binder system generally combines a binder and an electronic reminder component or electronic reminder module. Accordingly, the binder system is provided to merge a manual handwritten component with an electronic reminder component. The electronic reminder module electronically stores reminder events and provides at least one of an audible alarm signal or a visual alarm signal upon the occurrence of one of the entered reminder events.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to an electronic alarm system for a paper planner system, and more specifically to an electronic reminder component integrally combined with a binder to provide audio and visual reminder alarms for the user.

### BACKGROUND OF THE INVENTION

Electronic alarm systems and paper planner systems are well known in the art. While such systems according to the prior art individually provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a binder or planner system. The binder system generally comprises a binder and an electronic reminder component or electronic reminder module. The binder system is provided to merge a manual handwritten component with an electronic reminder component.

According to one embodiment, the binder of the binder system has a cover with an outwardly facing first surface and an inwardly facing second surface. In one embodiment the electronic component of the binder system is provided on the cover of the binder. In another embodiment an aperture is provided in the cover of the binder. In this embodiment at least a portion of the electronic component is provided in the aperture and extends from the first surface to the second surface. Preferably, the first panel of the electronic component extends through the first surface of the binder cover and the second panel of the electronic component extends through the second surface of the binder cover.

According to another embodiment, the electronic component has a first panel adjacent the first surface of the cover, and a second panel adjacent the second surface. Both the first panel and the second panel have input keys. In different embodiments, various input keys are provided. For example, the input keys may include a new reminder entry key to allow the user to enter a new electronic reminder, a scroll key to scroll through entered reminders, a snooze key to suspend the alarm indicators for a specific reminder for a period of time, and a dismiss key to end the alarm indicators for a specific reminder.

According to another embodiment, the electronic component has at least one indicator to indicate the occurrence of a reminder/alarm. One of the indicators is an audible indicator component that provides an audible alarm upon the occurrence of an entered reminder. Another of the indicators is a visual indicator that provides a visible alarm upon the occurrence of an entered reminder.

According to another embodiment, the electronic component further has a display. The display displays the time and date of entered reminders. In further embodiments the display may also display the current date and time, as well as being the display for a calculator feature of the electronic component.

According to yet another embodiment, the cover of the binder has a flap extension thereto. In this embodiment the electronic component is provided on the flap extension.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of an electronic reminder module with a document binder, with the document binder in the closed position;

FIG. 2 is a top plan view of the electronic reminder module and document binder of FIG. 1;

FIG. 3 is a top plan view of the electronic reminder module with a document binder of FIG. 1, with the document binder in the open position;

FIG. 4 is a side elevation view of the electronic reminder module with a document binder of FIG. 3;

FIG. 5 is a top plan view of one embodiment of an electronic reminder module;

FIG. 6 is a cross-sectional view about line 6-6 of FIG. 2;

FIG. 7 is a perspective view of another embodiment of an electronic reminder module with a document binder, with the document binder in the closed position;

FIG. 8 is a top plan view of the electronic reminder module with a document binder of FIG. 7, with the document binder in the open position; and,

FIG. 9 is a perspective view of another embodiment of an electronic reminder module with a document binder, with the document binder in the closed position.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

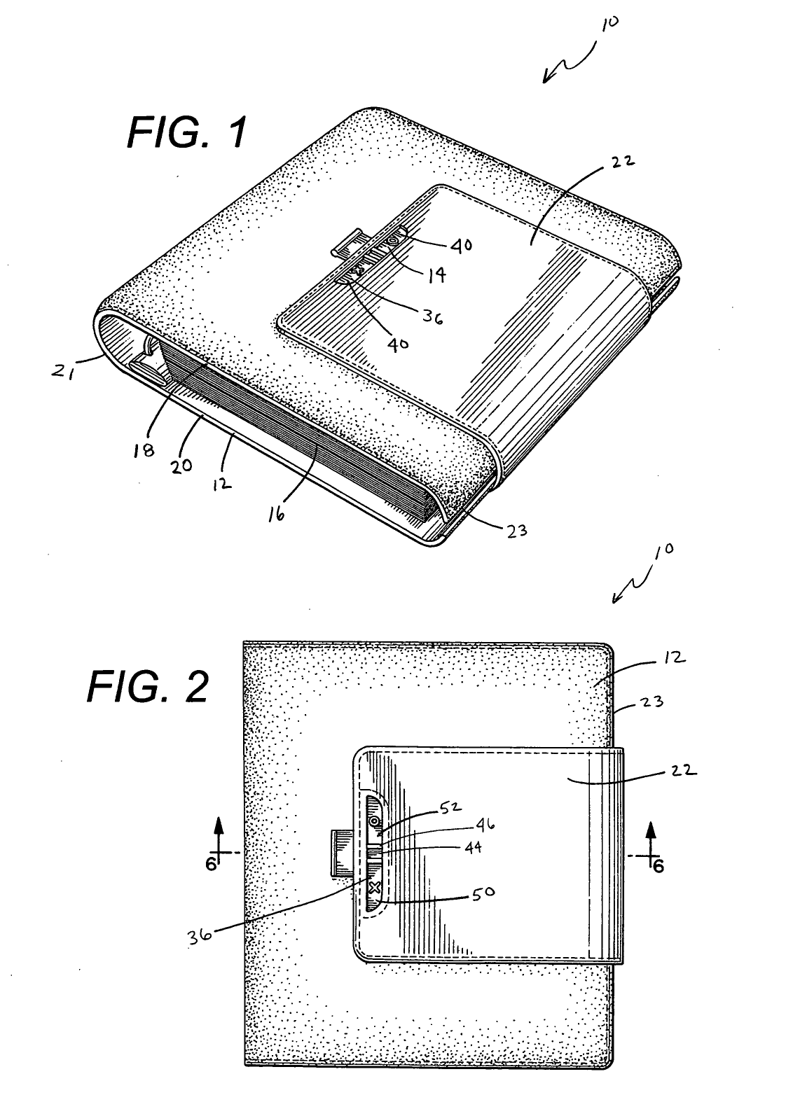

Referring now to the Figures, and specifically to FIGS. 1-3, there is shown a binder or planner system 10. The binder system 10 generally comprises a binder 12 and an electronic reminder component or electronic reminder module 14. The binder system 10 is provided to merge a manual handwritten component 16 with an electronic reminder component 14. As shown in FIG. 1, in one embodiment the manual handwritten component is a paper calendar or planner 16. In a preferred embodiment, the electronic reminder component 14 is permanently attached to the binder 12.

In one embodiment, the electronic component 14 that is merged with the handwritten component 16 is utilized to provide a reminder alarm upon the occurrence of an entered reminder. For example, the user may typically enter a new event, such as a meeting, in the handwritten planner component 16 by writing the information in the appropriate space in the calendar planner 16. In this example, the event is a meeting at 2:30 on Tuesday, Nov. 7, 2007 with the corporate management team. If the user would like an electronic alarm to be associated with this event the user may also enter the event in the electronic reminder component 14. For example, in one embodiment the user may enter the time and date of the event into the electronic component 14. In another embodiment the user may also be able to select the amount of advance time for the alarm to occur (i.e., 15 minutes). Accordingly, in this example the electronic reminder component 14 will provide an alarm signal at 2:15 indicating the occurrence of an event. When the alarm signal occurs the user can either permanently stop the alarm with a dismiss key, or temporarily stop the alarm with a snooze key. After stopping or terminating the alarm, the user will then turn to the daily manual planner 16 to be reminded of the specific event. Thus, this demonstrates the merging of an electronic reminder component 14 with a manual planning component 16.

As shown in the figures, in various embodiments the binder 12 has a front cover 18 and a back cover 20. The front cover 18 has an outwardly facing first surface 24 and an inwardly facing second surface 26. Similarly, the back cover 20 has an outwardly facing first surface 28 and an inwardly facing second surface 30. The front cover 18 and the back cover 20 generally meet at a binding 21.

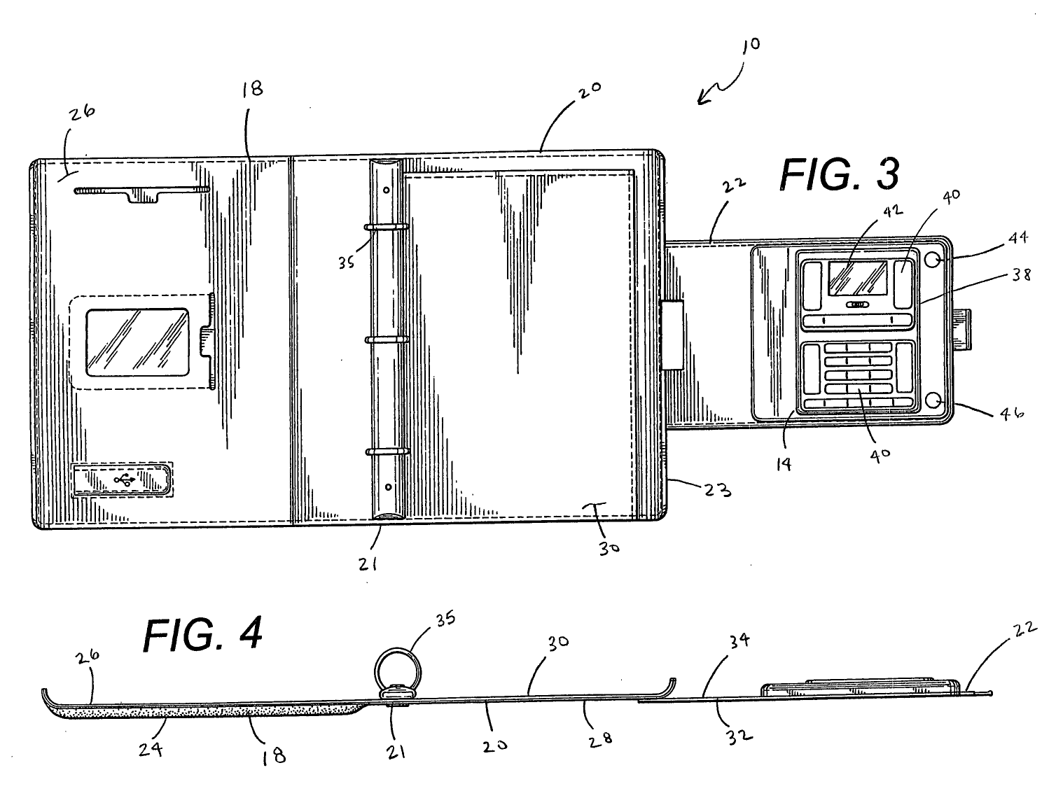

Referring now to the embodiments of FIGS. 1-6, the binder 12 further comprises a flap extension 22 extending from one of the front or back cover 18, 20. In a preferred embodiment, the flap extension 22 extends from the back cover 20 (as shown in FIGS. 3 and 4) and is adapted to be able to wrap around an edge 23 of the binder 12 to be positioned on the front cover 18 (as shown in FIGS. 1, 3 and 6). Typically, this edge 23 of the binder 12 opposes the binding 21 of the binder 12. Accordingly, this embodiment of the binder system 10 can be adjusted from an open position (as shown in FIGS. 3 and 4), to a closed position (as shown in FIGS. 1, 2 and 6). In the closed position the flap extension 22 assists in maintaining the binder 12 closed. The flap extension 22 also has an outwardly facing first surface 32 and an inwardly facing second surface 34. In this embodiment the outwardly facing first surface 32 is outwardly facing in both the open and closed positions.

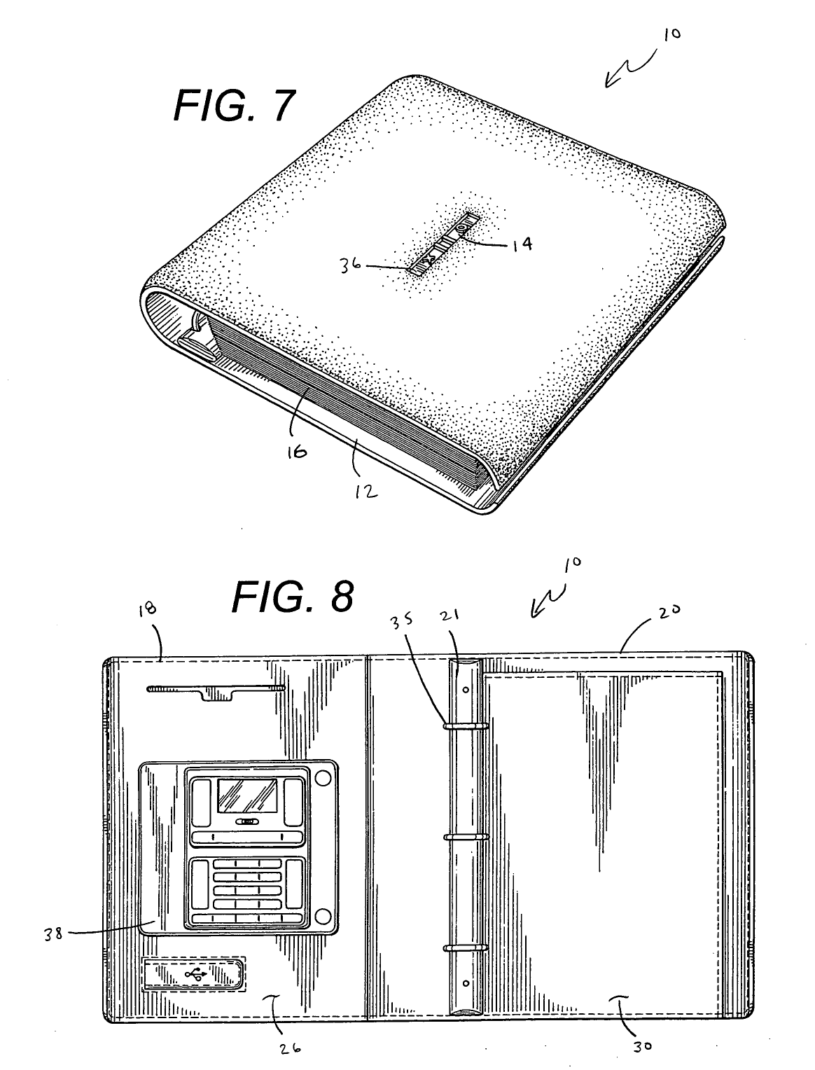

As shown in FIGS. 3 and 6, in one embodiment the binder 12 may also comprise a plurality of ring components 35 to assist in retaining the manual planning component 16. The ring components 35 in this embodiment are provided between the front and back covers 18, 20, and preferably at the binding 21 thereof. Different components may be utilized to retain the manual planning component 16 depending on the type of manual planning component 16 utilized therein.

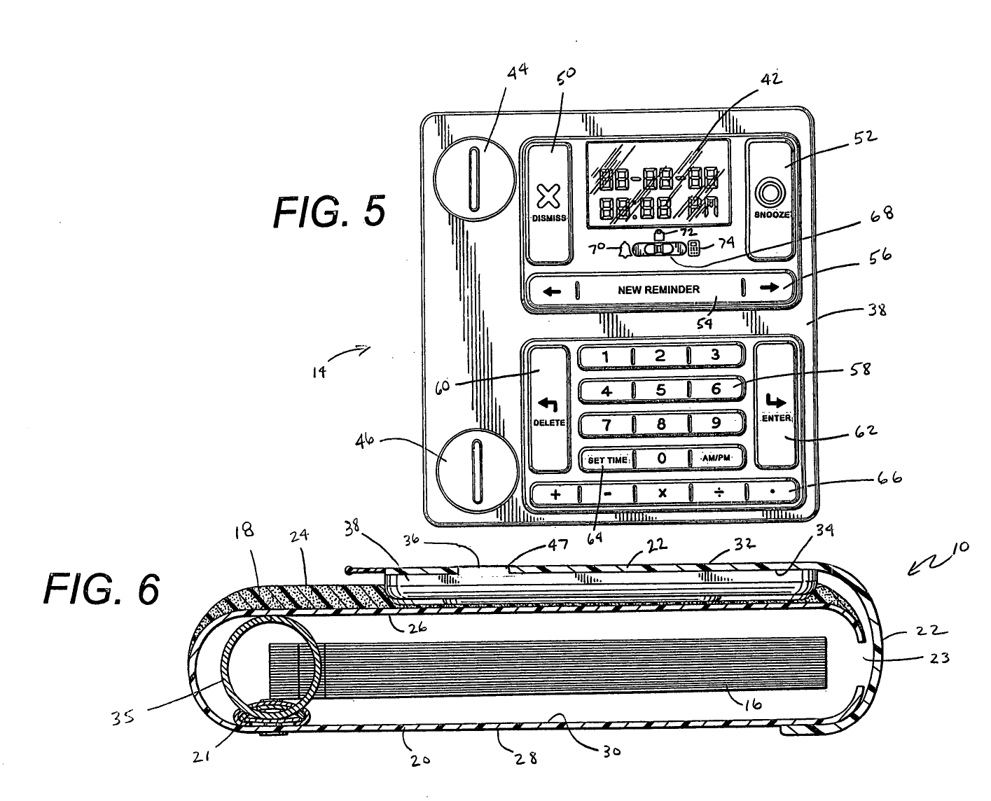

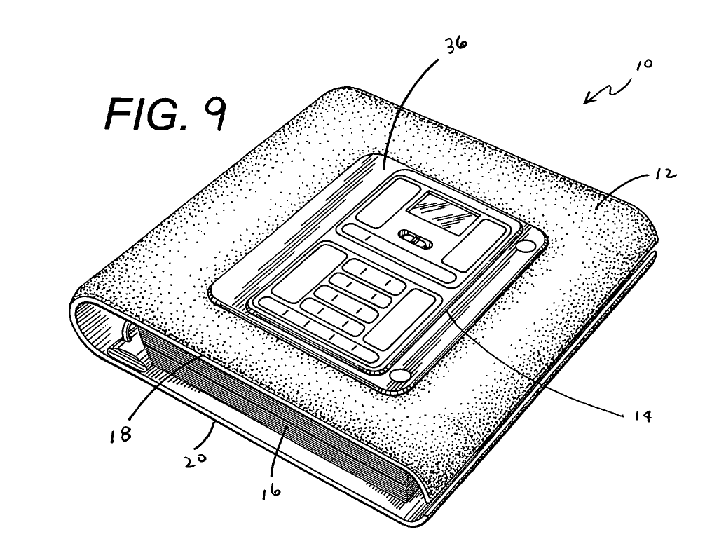

The electronic component 14 of the preferred embodiment is typically provided in one of the front cover 18, the back cover 20 or the flap extension 22. In one embodiment the electronic component 14 comprises a first or front panel 36 and a second or rear panel 38. The first panel 36 and the second panel 38 preferably both have input keys 40. Some of the input keys 40 on the second panel 38 may be the same as the input keys 40 on the first panel 36, while other input keys 40 on the second panel 38 may be different than any of the input keys 40 on the first panel 36. Typically, the input keys 40 on the different panels 36, 38 are connected to electronic circuitry (not shown) in the electronic component 14. The electronic circuitry typically includes some form of memory to allow the electronic component 14 to be able to store the alarms/reminders entered via the input keys 40. A power source (not shown), such as a battery, is also provided in the electronic component 14 to provide power for the electronic component 14. One or more of the panels 36, 38 may also have additional components. For example, in one embodiment the second panel 38 has a display screen 42. As shown in FIG. 5, the display screen 42 displays the time and date of an entered alarm/reminder. The electronic circuitry electrically connects the input members, display screen, indicator buttons, indicator components, memory and power source in the electronic component 14. Different embodiments of the first panel 36 are shown in FIGS. 7 and 9, and an embodiment of the second panel 38 is shown in FIG. 8.

In one embodiment the electronic component 14 may also have an indicator to indicate the existence of an alarm/reminder. The indicator may be one of an audible indicator, such as a speaker 44, and/or a visual indicator, such as a light 46. The audible indicator 44 preferably provides an audible alarm upon the occurrence of an entered reminder. The visual indicator 46 preferably provides a visible alarm, such as a light, upon the occurrence of an entered reminder.

In one embodiment, as shown in FIGS. 7 and 8, the electronic component 14 of the planner system 10 is provided in the front cover 18 of the binder 12, however, it is understood that it could be provided in the back cover 20 instead. In this embodiment, the front cover 18 of the binder 12 has an aperture or opening 47 therethrough which extends from the outwardly facing first surface 24 to the inwardly facing second surface 26. As shown in FIG. 7, at least a portion of the electronic component 14 may be provided in the aperture 47 with the first panel 36 of the electronic component 14 being adjacent the outwardly facing first surface 24 of the front cover 18. Further, as shown in FIG. 8, the second panel 38 of the electronic component 14 is adjacent the inwardly facing second surface 26 of the front cover 18.

In another embodiment, as shown in FIGS. 1-4 and 6, the electronic component 14 of the planner system 10 is provided in the flap extension 22 of the cover of the binder 12. In this specific embodiment, the flap extension 22 is an extension part of the rear cover 20 of the binder 12. In this embodiment, as best shown in FIGS. 3 and 4, the flap extension 22 of the binder 12 has an aperture 47 therethrough which extends from the outwardly facing first surface 32 to the inwardly facing second surface 34. As shown FIGS. 3 and 6, at least a portion of the electronic component 14 may be provided in the aperture 47 with the first panel 36 of the electronic component 14 being adjacent the outwardly facing first surface 32 of the flap extension 22, and the second panel 38 of the electronic component 14 being adjacent the inwardly facing second surface 34 of the flap extension 22.

Further, in a preferred embodiment the electronic component 14 of the planner system 10 is provided as an integral component of the binder 12. Accordingly, in such an embodiment the electronic component 14 cannot be removed from the binder 12. In alternate embodiments, however, the electronic component 14 may be able to be removed from the binder 12.

As shown in FIG. 7, the first panel 36 of the electronic component 14 has a plurality of input keys 40. In one embodiment, the input keys 40 of the first panel 36 comprise a dismiss key 50 and a snooze key 52. The dismiss key 50 allows the user to stop or end any alarm indicators for a specific reminder event/alarm, and the snooze key 52 allows the user to suspend the alarm indicators for a specific reminder event/alarm for a period of time referred to as snooze time. At the end of the snooze time period the alarm indicators will once again actuate until snoozed or dismissed by the user. The snooze cycle for any reminder event/alarm will continue until dismissed by the user. The first panel 36 may also have additional features, such as a visual indicator 46 and an audible indicator 44. In this embodiment the visual indicator 46 comprises a LED light 46 that blinks to provide a visible alarm upon the existence of the occurrence of an entered reminder condition. Further, the audible indicator 44 in this embodiment comprises a speaker 44.

Referring to FIG. 8, the second panel 38 of the electronic component 14 also has a plurality of input keys 40. One embodiment of the second panel 38 is shown in more detail in FIG. 5, wherein in this embodiment the input keys 40 of the second panel 38 comprise a dismiss key 50, a snooze key 52, a new reminder entry key 54, a scroll key 56, a plurality of number keys 58, a delete key 60, an enter key 62 and a set time key 64. Additionally, different embodiments may also include calculator function keys 66 as input keys 40. The second panel 38 also has a selector button 68 to allow the user to select the alarm mode 70, lock mode 72 or calculator mode 74.

Typically, the snooze key 52 and dismiss key 50 on the second panel 38 operate similarly, such as explained above, to those same keys on the first panel 36. The new reminder entry key 54 is utilized as a prompt key to indicate the desired entry of a new electronic reminder/alarm into the electronic component 14. Accordingly, when a new reminder, such as a new event is desired to have an alarm associated therewith, the user will initially key in the new reminder by depressing the new reminder key 54. After the new reminder key 54 has been depressed, the user is able to enter the date, and time for the alarm to occur. The user enters this information via the number keys 58 on the second panel 38 of the electronic component 14. To set the alarm data into the memory of the electronic component 14, the user depresses the enter key 62. Conversely, to delete any entered data for a specific alarm, or to delete an alarm entirely, the user will depress the delete key 60.

After a reminder/alarm with associated data (i.e., time and date) has been entered into the electronic component 14, the user can scroll through the entered reminders/alarms via the forward and backward scroll keys 56. The reminders/alarms are typically maintained in the memory of the electronic component 14 in date and time order.

In alternate embodiments, the display panel 42 of the electronic reminder module 14 is programmed to be able to display a clock feature, such as the present time and date, as well as being programmed to be utilized as the display for the calculator in the calculator mode 74.

In different embodiments the indicators are provided on one of more of the first panel 36 and the second panel 38 of the electronic component 14. For example, as shown in FIG. 1, the first panel 36 may have lights 46 that illuminate upon the existence of an alarm/reminder, as well as a speaker 44 that provides a sound upon the existence of an alarm/reminder. Similarly, as shown in FIG. 3, the second panel 36 may have lights 46 that illuminate upon the existence of an alarm/reminder, as well as a speaker 44 that provides a sound upon the existence of an alarm/reminder. By having the visual and audible alarm indicators 44, 46 on both the first and second panels 36, 38 of the electronic reminder module 14 the user can be alerted as to the existence of an alarm when the binder 12 is in either the open or closed positions. Additionally, the user is able to control whether the audible and/or visual alarm indicators are turned on and off. Accordingly, the user may be able to obtain only visual alarm indications 46 (for example to prevent an audible alarm from interrupting a phone conference), only audible alarm indications 44, or both types of indications.

As shown in the figures, in one embodiment the first and second panels 36, 38 of the electronic component 14 are integrally combined in a single electronic component 14. Accordingly one side of the electronic component 14 shows through the first surface of the cover and another side of the electronic component 14 shows through the second surface of the cover of the binder 12. In alternate embodiments the first and second panels 36, 38 of the electronic component 14 are distinct components, but are electrically connected.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A binder system comprising:
a binder having a cover with an outwardly facing first surface and an inwardly facing second surface; and,
an electronic component in the cover, the electronic component having a first panel adjacent the first surface of the cover, the first panel having input keys, and a second panel adjacent the second surface, the second panel having additional input keys and a display screen, the electronic component further comprising an indicator to indicate the existence of an alarm.

2. The binder system of claim 1, wherein the cover has a flap extension thereto, and wherein the electronic component is provided on the flap extension.

3. The binder system of claim 1, wherein one of the input keys on the second panel is a new reminder entry key to allow the user to enter a new electronic reminder.

4. The binder system of claim 3, wherein another of the input keys on the second panel is a scroll key to scroll through entered reminders.

5. The binder system of claim 3, wherein the electronic component further comprises an audible indicator component that provides an audible alarm upon the occurrence of an entered reminder.

6. The binder system of claim 3, wherein the electronic reminder module further has electronic circuitry that stores alarm data entered with the input keys.

7. The binder system of claim 6, wherein the display displays the time and date of the entered reminder.

8. The binder system of claim 1, further comprising a visual indicator on the first panel, the visual indicator providing a visible alarm upon the occurrence of an entered reminder.

9. The binder system of claim 1, wherein the input keys on the first panel comprise a snooze key and a dismiss key, the snooze key suspending alarm indicators for a specific reminder for a period of time and the dismiss key ending alarm indicators for a specific reminder.

10. The binder system of claim 1, further comprising an aperture in the cover, at least a portion of the electronic component being provided in the aperture and extending from the first surface to the second surface, the first panel of the electronic component extending through the first surface of the binder cover and the second panel of the electronic component extending through the second surface of the binder cover.

11. A planner system comprising:
a binder having a cover and being adapted to hold a plurality of documents, the cover having an outwardly facing first surface, an inwardly facing second surface, and an opening through the cover extending from the first surface to the second surface; and,
an electronic reminder module having a portion thereof in the opening, the electronic reminder module having a front portion adjacent the first surface of the cover and a rear portion adjacent the second surface of the cover, the electronic reminder module comprising electronic circuitry to accept reminder events, and the electronic reminder further comprising at least one of an audible alarm indicator and a visual alarm indicator to provide an alarm signal upon the occurrence of one of the entered reminder events.

12. The planner system of claim 11, wherein the electronic reminder module further comprises at least one of an alarm dismiss key and an alarm snooze key on the front portion of the electronic reminder module.

13. The planner system of claim 11, further comprising both of the audible alarm indicator and the visual alarm indicator as part of the electronic reminder module, the visual alarm indicator being provided on the front portion of the electronic reminder module.

14. The planner system of claim 11, further comprising a scroll key on the rear portion of the electronic reminder module to allow a user to scroll through the reminder events.

15. The planner system of claim 11, further comprising a calculator as a component of the rear portion of the electronic reminder module.

16. The planner system of claim 11, wherein the electronic reminder module has input members at the rear portion of the electronic reminder module to allow a user to enter the time and date of a new reminder.

17. The planner system of claim 16, further comprising a display panel on the rear portion of the electronic reminder module to display reminder data.

18. The planner system of claim 11, wherein the visual alarm indicator comprises a light.

19. The planner system of claim 11, further comprising a flap portion extending from the cover, the opening in the cover being provided in the flap portion of the cover, and the electronic reminder module being positioned at least partially in the opening in the flap portion.

20. A binder system comprising:
a binder having a cover with an outwardly facing first surface and an inwardly facing second surface; and,
an electronic component having at least a portion thereof in the cover, the electronic component having a first panel adjacent the first surface of the cover, the first panel having input keys, a second panel adjacent the second surface, the second panel having additional input keys and a display screen, and electronic circuitry electrically connected to the input keys and the display screen, the electronic circuitry allowing the user to enter a time and date of a new reminder with the input keys on the second panel, wherein the display screen displays the time and date of the entered reminders, wherein the input keys on the first panel comprise at least one of a snooze key and a dismiss key, the snooze key suspending alarm indicators for a specific reminder for a period of time and the dismiss key ending alarm indicators for a specific reminder, the electronic component further comprising one of an audible indicator alarm and a visible indicator alarm to provide an alarm indication upon the occurrence of an entered reminder.

21. The binder system of claim 20, wherein the cover has a flap extension thereto, and wherein the electronic component is provided in the flap extension.

22. A planner system comprising:
a binder having a cover and being adapted to hold a plurality of documents, the cover having an opening and an electronic reminder module to electronically store reminder events being provided in the opening, the electronic reminder module comprising a display panel, a plurality of keys, electronic circuitry connecting the display panel and the keys, and at least one of an audible alarm indicator and a visual alarm indicator to provide an alarm signal upon the occurrence of one of the entered reminder events, wherein a user can enter a time and date of a new reminder with the input keys, wherein the display screen displays the time and date of the entered reminders, wherein another of the input keys comprises at least one of a snooze key and a dismiss key, the snooze key suspending the alarm signal for a specific reminder for a period of time and the dismiss key ending the alarm signal indefinitely for a specific reminder.
